(19) United States
(12) Patent Application Publication
(10) Pub. No.: US 2007/0230776 A1
(43) Pub. Date: Oct. 4, 2007

(54) System and method of testing imaging equipment using transformed patterns

(75) Inventors: Albert D. Edgar, Austin, TX (US); Ajit S. Bopardikar, Austin, TX (US)

Correspondence Address: ANDERSON LAW GROUP, PLLC, 9600 GREAT HILLS TRAIL, 150W, AUSTIN, TX, 78759, US

(73) Assignee: SozoTek, Inc., Austin, TX (US)

(21) Appl. No.: 11/452,701

(22) Filed: Jun. 13, 2006

Related U.S. Application Data
(60) Provisional application No. 60/789,112, filed on Apr. 4, 2006.

(51) Int. Cl. G06K 9/00

(52) U.S. Cl. 382/162

(57) ABSTRACT

Systems and methods for creating an image target and performing for diagnostic testing and for of an image capture device include choosing a pattern appropriate for image testing; embedding the pattern into a reversible domain; adding a random phase component in the reversible domain; transforming the pattern from the reversible domain to an inverse of the reversible domain; and producing an image target for testing the image capture device from the transformed pattern. A method for testing an image capture device includes receiving image data representative of a photographic image of a target image captured by the image capture device; transforming the image data into a reversible domain to detect one or more patterns embedded in the reversible domain of the target image; and comparing the reversible domain image data with the one or more geometric patterns embedded in the reversible domain.

### CROSS-REFERENCE TO RELATED APPLICATION

This application claims priority to U.S. Provisional Ser. No. 60/789,112, filed Apr. 4, 2006, having the same inventors, and is incorporated herein by reference in its entirety.

### TECHNICAL FIELD

This invention relates to test instruments and procedures for image capture systems and devices, particularly digital image capture systems such as digital cameras and mobile phone embedded cameras.

### SUMMARY

In one aspect, a method for creating an image target for diagnostic testing of an image capture device but is not limited to choosing a pattern appropriate for image testing; embedding the pattern into a reversible domain; adding a random phase component in the reversible domain; transforming the pattern from the reversible domain to an inverse of the reversible domain; and producing an image target for testing the image capture device from the transformed pattern. In addition to the foregoing, other method aspects are described in the claims, drawings, and text forming a part of the present application.

In another aspect, a method for testing an image capture device is provided including receiving image data representative of a photographic image of a target image captured by the image capture device; transforming the image data into a reversible domain to detect one or more patterns embedded in the reversible domain of the target image; and comparing the reversible domain image data with the one or more geometric patterns embedded in the reversible domain. In addition to the foregoing, other method aspects are described in the claims, drawings, and text forming a part of the present application.

In another aspect for a computer program product includes but is not limited to a signal bearing medium bearing at least one of one or more instructions for choosing a pattern appropriate for image testing; one of one or more instructions for embedding the pattern into a reversible domain; one of one or more instructions for adding a random phase component in the reversible domain; one of one or more instructions for transforming the pattern from the reversible domain to an inverse of the reversible domain; and one of one or more instructions for producing an image target for testing the image capture device from the transformed pattern; one of one or more instructions for receiving image data representative of a photographic image of a target image captured by the image capture device; and one or more instructions for transforming the image data into a reversible domain to detect one or more patterns embedded in the reversible domain of the target image. In addition to the foregoing, other method aspects are described in the claims, drawings, and text forming a part of the present application.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer. In addition to the foregoing, other system aspects are described in the claims, drawings, and text forming a part of the present application.

In addition to the foregoing, various other method, system, computer program product, and/or imaging tool aspects are set forth and described in the text (e.g., claims and/or detailed description) and/or drawings of the present application.

### BRIEF DESCRIPTION OF THE DRAWINGS

A better understanding of the subject matter of the application can be obtained when the following detailed description of the disclosed embodiments is considered in conjunction with the following drawings, in which:

FIG. 1 is a block diagram of an exemplary computer architecture that supports the claimed subject matter of the present application;

FIG. 2 is a flow diagram of a method in accordance with an embodiment of the subject matter of the present application;

FIG. 3 illustrates a flow diagram of a method in accordance with an embodiment of the subject matter of the present application;

FIG. 4 illustrates a 12×12 alternating square geometric pattern positioned in an upper left quadrant in a frequency depiction for creating an exemplary target image in accordance with an embodiment of the present application;

FIG. 5 illustrates an alternate geometric pattern positioned in an upper left quadrant in a frequency depiction for creating an exemplary target image in accordance with an embodiment of the present application;

FIG. 6 illustrates a transformed image of the frequency depiction with geometric pattern of the target of FIG. 4 in accordance with an embodiment of the present application;

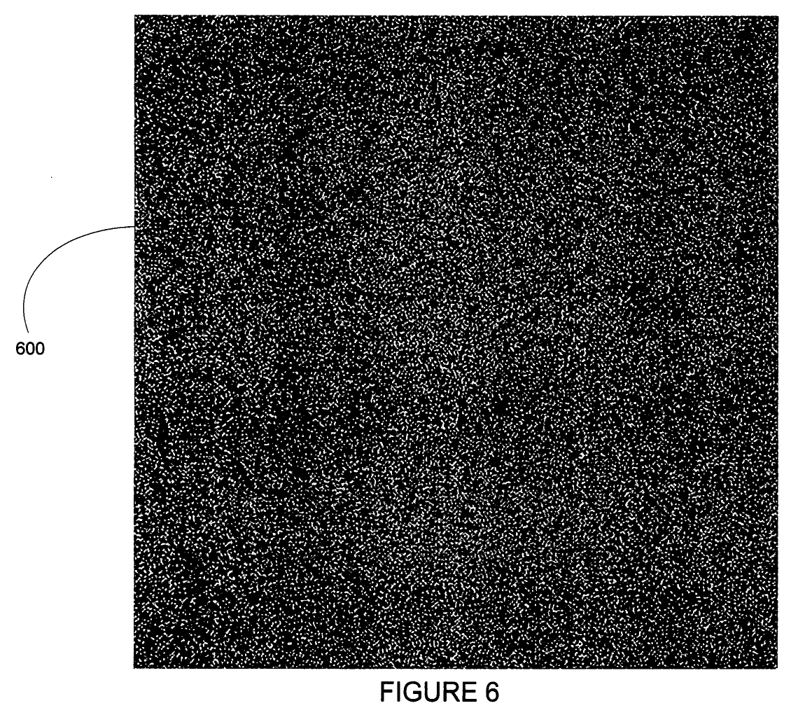

FIG. 7 illustrates a section of a photograph of the target image in accordance with an embodiment of the present application; and

FIG. 8 illustrates a transformed version of the section of the photograph illustrated in FIG. 8 in accordance with an embodiment of the present application.

### DETAILED DESCRIPTION OF THE DRAWINGS

In the description that follows, the subject matter of the application will be described with reference to acts and symbolic representations of operations that can be performed, at least in part, by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer which reconfigures or otherwise alters the operation of the computer in a manner well understood by those skilled in the art. The data structures where data is maintained are physical locations of the memory that have particular properties defined by the format of the data. However, although the subject matter of the application is being described in the foregoing context, it is not meant to be limiting as those of skill in the art will appreciate that some of the acts and operations described hereinafter can also be implemented in hardware, software, and/or firmware and/or some combination thereof.

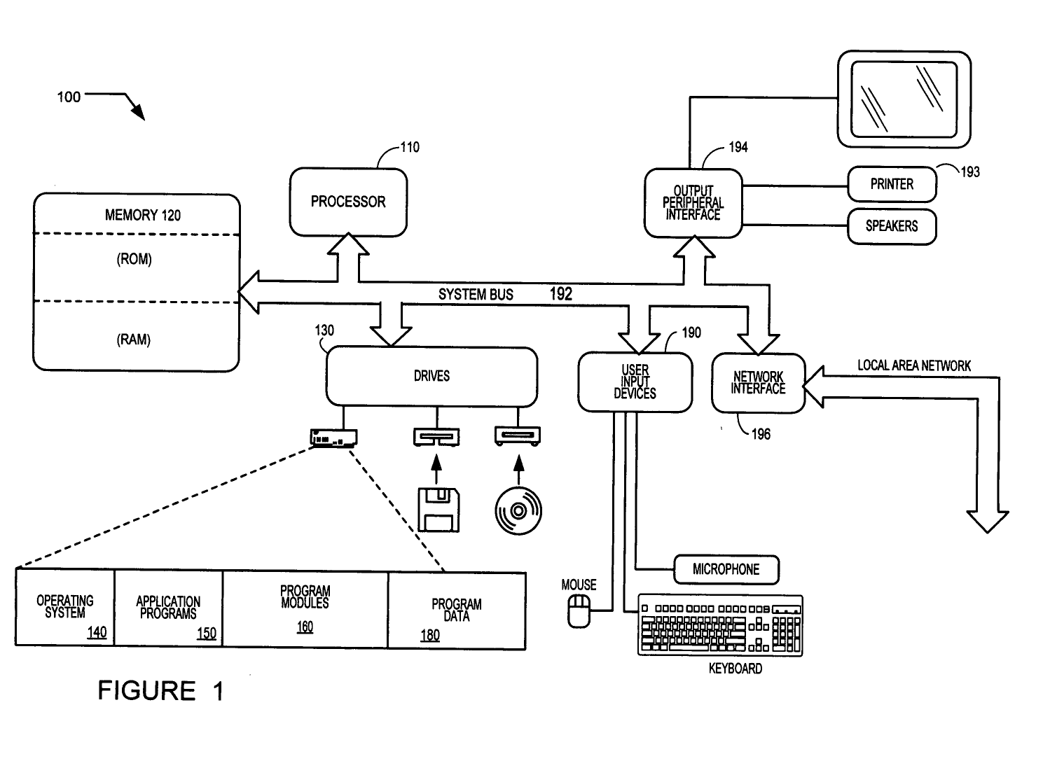

With reference to FIG. 1, depicted is an exemplary computing system for implementing one or more embodiments herein. FIG. 1 includes a computer 100, which could be a portable computer, including a processor 110, memory 120 and one or more drives 130. The drives 130 and their associated computer storage media, provide storage of computer readable instructions, data structures, program modules and other data for the computer 100. Drives 130 can include an operating system 140, application programs 150, program modules 160, and program data 180. Computer 100 further includes user input devices 190 through which a user may enter commands and data. Input devices can include an electronic digitizer, a microphone, a keyboard and a pointing device, commonly referred to as a mouse, trackball or touch pad. Other input devices may include a joystick, game pad, satellite dish, scanner, and the like. In one or more embodiments, user input devices 190 are portable devices that can direct display or instantiation of applications running on processor 110.

These and other input devices can be connected to processor 110 through a user input interface that is coupled to a system bus 192, but may be connected by other interface and bus structures, such as a parallel port, game port or a universal serial bus (USB). Computers such as computer 100 may also include other peripheral output devices such as speakers and/or display devices, which may be connected through an output peripheral interface 194 and the like. In particular, in one embodiment, computer 100 is coupled to printer 193 to produce one or more target images created according to embodiments herein.

Computer 100 may operate in a networked environment using logical connections to one or more remote computers, such as a remote computer or remote network printer. The remote computer can include a personal computer, a server, a router, a network PC, a peer device or other common network node, and may include many if not all of the elements described above relative to computer 100. Networking environments are commonplace in offices, enterprise-wide computer networks, intranets and the Internet. For example, in the subject matter of the present application, computer 100 may comprise the source machine from which data is being migrated, and the remote computer may comprise the destination machine. Note, however, that source and destination machines need not be connected by a network or any other means, but instead, data may be migrated via any media capable of being written by the source platform and read by the destination platform or platforms. When used in a LAN or WLAN networking environment, computer 100 is connected to the LAN through a network interface 196 or an adapter. When used in a WAN networking environment, computer 100 typically includes a modem or other means for establishing communications over the WAN to environments such as the Internet. It will be appreciated that other means of establishing a communications link between the computers can be implemented.

Embodiments of the present disclosure are directed to a system and method for creating test patterns and using the results from those test patters to test an image capture device, such as a camera, digital camera, camera phone and the like. The test patterns assist in measuring the capacity of camera phones, such as VGA and low Mega pixel phones, to reproduce fine detail.

Computer 100 can include modules for implementing embodiments of the present disclosure for creating target images for image device testing. For example, in one embodiment, computer 100 can be used to alter a geometric pattern to create a spatially merged pattern to prevent an image capture device from attempting to self-correct for noise, sharpness and resolution. More particularly, as described in more detail below, one or more test patterns for an image capture device are spatially merged to appear as a homogeneous surface, but designed to enable a transform operation on the digital representation of a photograph taken of the test patterns to generate geometric shapes for data interpretation. The present disclosure, in one embodiment, implements a transform to spatially merge one or more test patterns. The individual test patterns are made distinguishable by implementing the transform. A transform can translate between a separated space and a merged real space in which the image is made. By spatially merging the measurement of noise, sharpness, and resolution, the effects of a “real world” blend of textures is more closely simulated. As a result, testing of a camera's ability to capture pleasing and useful images is accurate in contrast to known methods.

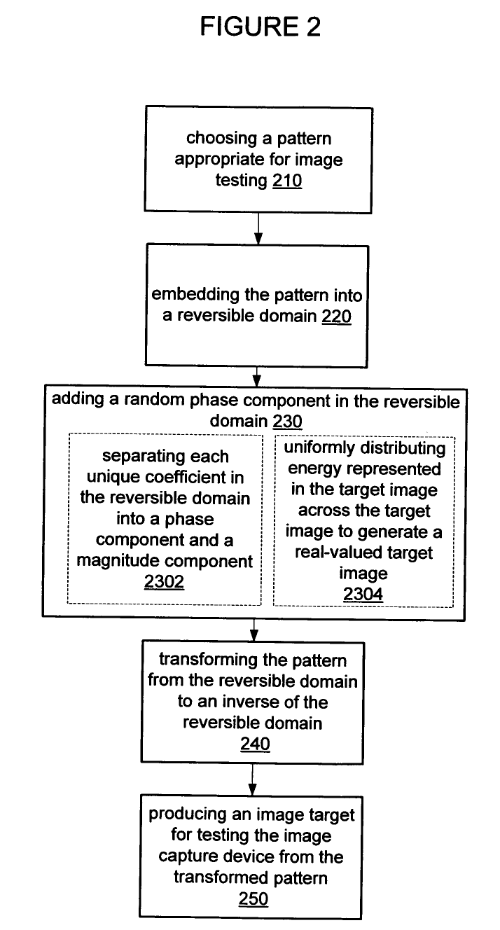

Referring to FIG. 2, a flow diagram illustrates a method for creating a test pattern. Block 210 provides for choosing a pattern appropriate for image testing. In one embodiment, the native test pattern is a checkerboard of alternating dark gray and light gray squares. As one of skill in the art with the benefit of the present disclosure will appreciate, a gray checkerboard is one of many possible targets. For example, in another embodiment, a chrominance component can be included with the checkerboard, for example in CIE-L*a*b* color space. The a*b* color dimension checkers could be at different angles, such as the ±30 degrees of conventional lithography, and at a different size, ideally larger than the L squares. Thus, a single target can be configured to capture color resolution and noise separately from traditional luminance resolution and noise.

In another embodiment, the target pattern can include alternating light and dark triangles that form two triplets within a hexagon. The alternating light and dark triangles within a hexagon beneficially provides frequency angle agnostic testing results.

In another embodiment, impulses-type patterns, such as “stars” can be included, which can be positioned, for example, on a hexagonal grid or a random grid. Once transformed, the sandpaper target would appear the same to the eye as a checkerboard originated one. The star impulses have an advantage of focusing equal energy in smaller frequency bands, thus being able to detect and measure weaker signals or higher frequencies in a noisier image. Also because the stars cover less frequency space, a wider blank frequency space is available for more accurate noise measurement. With stars it is important to measure the total energy within the star, not the energy at the center, as can be done with the checkerboards. Any blurring of the stars, caused by limiting the transformed area, or integrating areas of differing magnifications as in a barrel distorted image, causes the stars to be broader but with a lower peak, the total energy within each star is however the same.

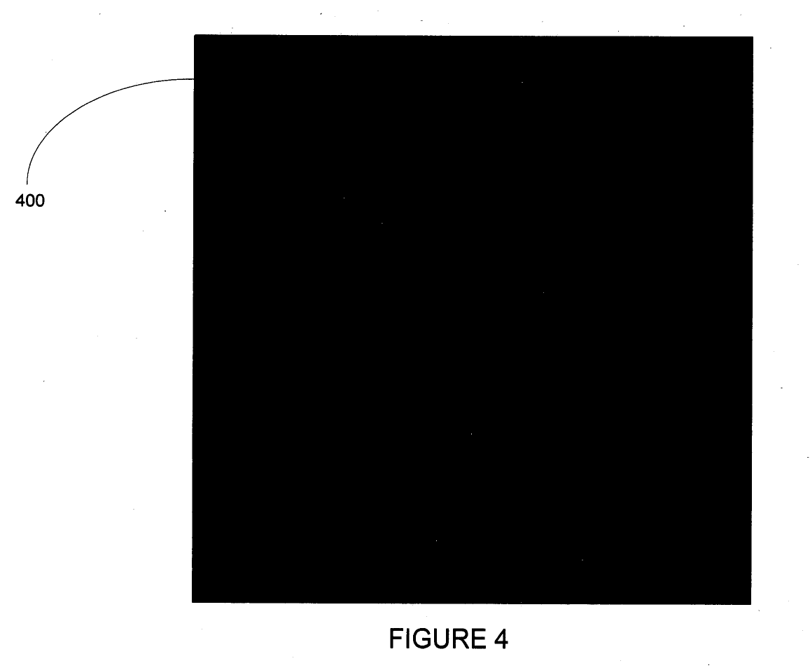

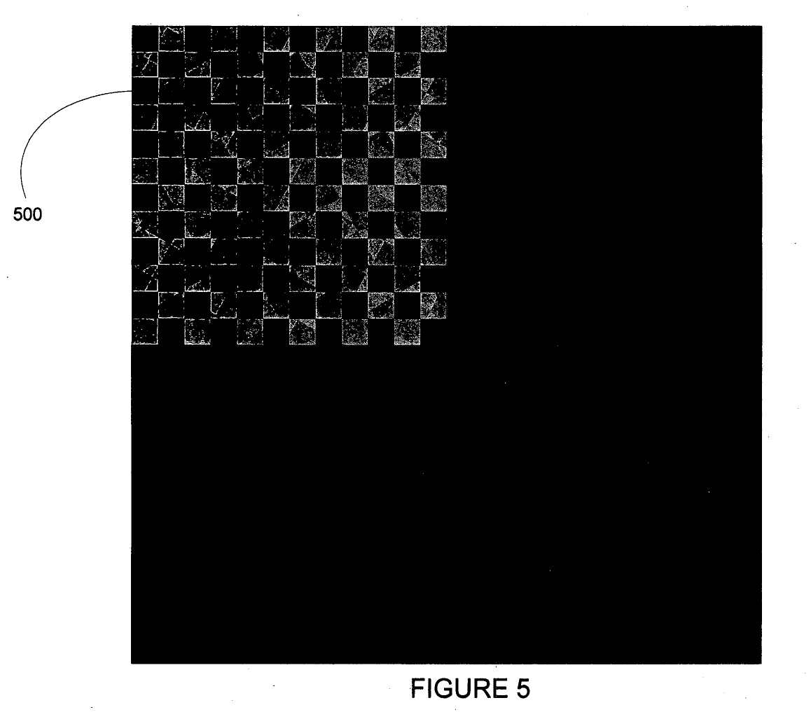

Referring now to FIG. 4, an exemplary target 400 is illustrated. As shown, the target includes alternating gray squares placed in the upper left-hand quadrant in a frequency domain wherein the upper left corner is identified as being zero frequency. FIG. 5 illustrates another exemplary target 500 wherein several geometrical shapes forming a pattern in the upper left-hand quadrant in a frequency domain. More particularly, FIG. 5 illustrates shapes for implementing a target in the CIE L*a*b* color space. One of skill in the art will appreciate that other color spaces are possible for implementing the embodiments disclosed herein for a target, such as YUV space of JPEG encoding, as well as others color spaces. CIE L*a*b* is provided as an example color space.

Referring back to FIG. 2, block 220 provides for embedding the pattern into a reversible domain. According to one embodiment, the Fourier transform is used as the reversible domain. Other reversible domains can be used, such as a reversible discrete cosine transform, reversible discrete sine transform, and the like, as will be appreciated by those of skill in the art. In this case, the a* and b* channels of CIE L*a*b* have been derived from the L* channel checkerboard at 1.4× lower frequency and tilted at +30 and −30 degrees as illustrated in FIG. 5. Also the top octave has been filled with zero so that effective resizing will be done perfectly by the Fourier transform rather than imperfectly by the printer software.

According to the embodiment, a 12×12 checkerboard of dark gray and light gray squares, is embedded in the frequency domain to enable an inverse Fourier transform to be performed to achieve a final target. In one embodiment, the pattern is configured to span a frequency of 0.1875 cycles/pixel.

Block 230 provides for adding a random phase component in the reversible domain. More particularly, according to an embodiment, the phase for each unique Fourier coefficient. Optional block 2302 provides for separating each frequency domain coefficient into a phase component and a magnitude component. The separating of each frequency domain coefficient enables locating each phase component for each unique Fourier coefficient. The phase component can be randomized over the entire phase circle. Randomizing the phase over an entire phase circle produces a photographable target that resembles sandpaper. Displayed within block 230 is block 2304, which provides for uniformly distributing energy represented in the target image across the target image to generate a real-valued target image. More particularly, randomizing the phase uniformly distributes the energy in the target image across the surface of the target image. The randomizing can include using one of a symmetric random, anti-symmetric random or a pure random phase component. If an anti-symmetric random phase is used, the anti-symmetric phase results in a real-valued target image, as will be understood by those skilled in the art. A symmetric random and pure random phase component will result in real and complex target image values.

Block 240 provides for transforming the pattern from the reversible domain to an inverse of the reversible domain. In one embodiment, the pattern is transformed with a two-dimensional inverse Fourier transform. The resulting target image can, therefore, be configured with no spatial separation. If a checkerboard-type pattern is chosen in block 210, a checkerboard will be contained in each fragment of the target image. Thus, a camera with self-correcting abilities will have to capture and process the target image in an integrated manner, and be unable to smooth and/or sharpen areas when taking a photograph of the target image.

Block 250 provides for producing an image target for testing the image capture device from the transformed pattern. In one embodiment, the target can be scaled to 8 bits for printing at 2048×2048 pixels. As is known by one of skill in the art, typical printers are capable of printing at a gamma of approximately 2, resulting in a signal that can be pre-compensated by the inverse normally, approximately a square root. Exemplary printing parameters of target images can include printing using a gamma of 1.8 and at 200 dpi, at which resolution the resulting target image spanned an area of about 10.25×10.25 inches. For the medium and higher mega pixel image capture devices, a larger target can be constructed with the checkerboard spanning the same spatial frequency by containing more geometric pattern coverage. Such an image target can be printed at a higher dots-per-inch resolution, or according to system requirements.

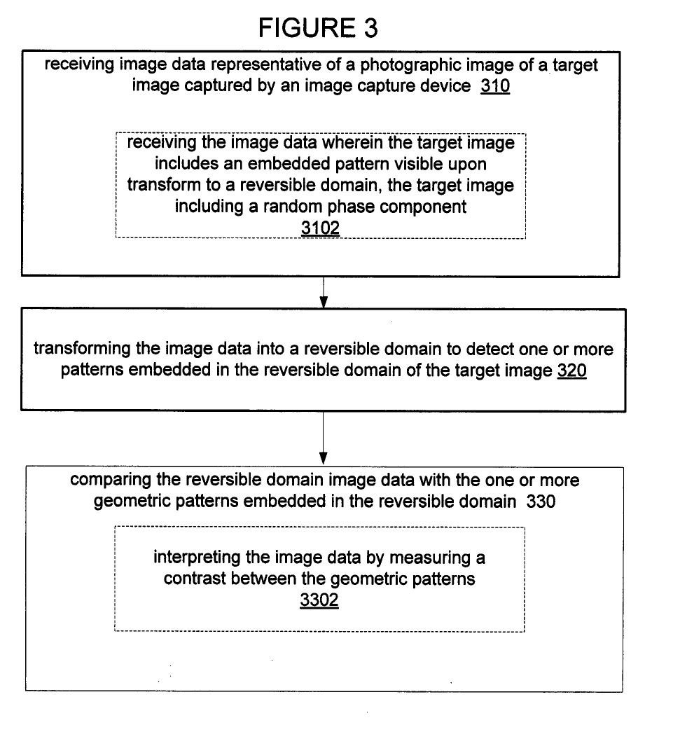

Referring now to FIG. 3, another flow diagram illustrates a method for operating on data resulting from photographing the target image. Block 310 provides for receiving image data representative of a photographic image of a target image captured by the image capture device. The data can include an image taken by a digital camera, a scan of a photograph taken by a film camera, or any digital representation of an image taken by an image capture device for which the image qualities of which are sought to be tested.

Block 3102 provides for receiving the image data wherein the target image includes an embedded pattern visible upon transform to a reversible domain, the target image including a random phase component. The image data can include parameters particular to the method corresponding to how an image capture device collected the image data. For example, a target image created in accordance with embodiments herein can be captured with an image device. Parameter appropriate for analyzing the image data include the distance at which the image capture device is placed from the target image, and the dimensions of the geometric pattern embedded in the reversible domain, such as a frequency domain, of the target image.

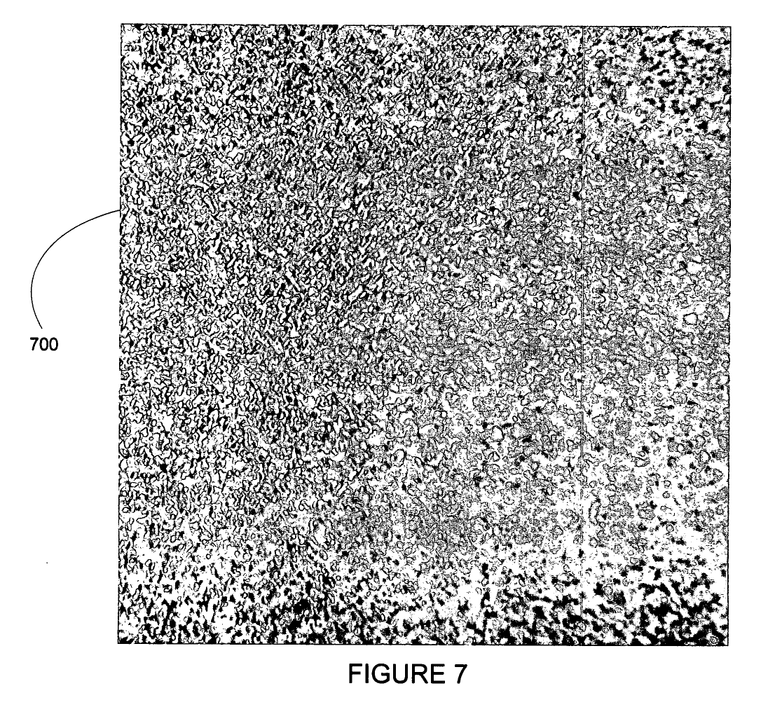

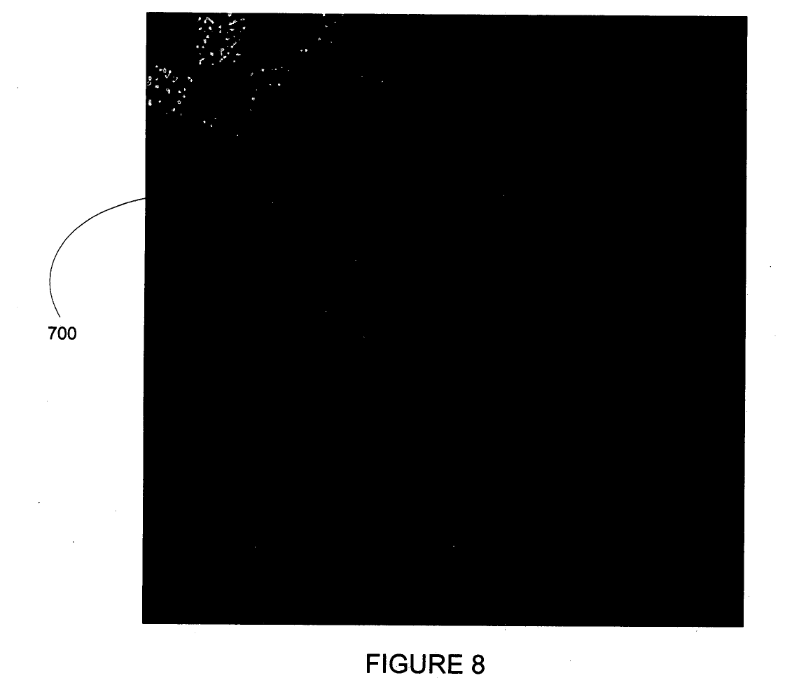

Block 320 provides for transforming the image data into a reversible domain to detect one or more patterns embedded in the reversible domain of the target image. In one embodiment, after the target image is imaged, the resulting image data is transformed by applying a two-dimensional Fourier transform to enable display and data manipulation of the embedded patterns. If the reversible domain is a Fourier frequency domain, because the inverse transform is in the spatial frequency domain, there is a substantially direct correspondence between position and two-dimensional frequency. Referring to FIG. 8, each fragment of the image captured by the imaging system of the randomized “sandpaper” target contains a checkerboard pattern, as in a hologram. However also like a hologram, the area of the fragment is proportional to the resolution with which the checkerboard is seen in the inverse transform. If the area is too small, it is difficult to distinguish checker edges from the noise within each checker, and if smaller still, the individual checkers themselves are not resolved. On the other hand, it is useful to limit the area somewhat in order to measure the sharpness and noise at different places in the image. Sharpness is typically highest in the middle of an image and falls off toward the corners. If the entire image is transformed, the measurement will represent an integrated average over the entire image. Further, the size of the geometric pattern is inverse to the magnification of the imager. Many image capture devices exhibit barrel distortion, in which the magnification varies across the field. If the entire frame is transformed, geometric patterns of differing sizes will be averaged, blurring the higher frequency geometric shapes and giving a false indication. For these reasons, one embodiment is directed to transforming and analyzing the image data in pieces, or to using a centered piece of the image. Thus, referring now to FIG. 7, the target image is photographed, and a section of the photographed target is illustrated 700. The transform of the section illustrated in FIG. 7 is illustrated in FIG. 8.

Referring back to FIG. 3, block 330 provides for comparing the reversible domain image data with the one or more geometric patterns embedded in the reversible domain. More particularly, comparing the frequency domain image data to the one or more patterns originally embedded in the target image in the frequency domain enables analysis of the abilities of the image capture device. Depicted within block 330 is shown block 3302, which provides for interpreting the image data by measuring a contrast between one or more geometric patterns. For example, the amount of contrast between light and dark colored geometric patterns can provide a measure of signal-to-noise as a function of frequency and angle. Depicted within block 330 is block 3304, which provides for performing two dimensional signal-to-noise analysis. One method of performing a signal-to-noise analysis is to determine the power in each geometric shape of a located pattern. The two dimensional signal-to-noise analysis allows the image data to be used to determine the total information capacity of an image capture device. For example, the total amount of information bits can be determined. The total amount of information bits corresponds to the ability of an image capture device to capture beauty and patterns useable to the eye in target recognition. By determining the total information capacity of the image capture device, a camera or other image capture device with self-correcting abilities will not be able to “cheat” by smoothing or otherwise altering the data captured. Thus, the measurement gives a true metric of usefulness.

FIG. 8 illustrates a transformed version of a portion of exemplary image data 800. The transformed version illustrates the reemergence of the geometric pattern. As shown, the placement of the zero frequency in the upper left corner in the transformed image data 800 becomes apparent. The frequency limits and noise of the image are thus detectible. For a geometric pattern including alternating squares, one metric that corresponds well with visual clarity is how many squares can be distinguished in the presence of the noise. In one embodiment, a computer analysis program can be used to identify the location of the geometric shapes within a pattern. As will be appreciated, many methods for identifying geometric shapes can be used. A maximum/minimum distribution of information bit determination, a statistical sampling and fitting, a Markov process and other types of methods are within the scope of the present application.

According to one embodiment, if alternating squares are used as a test image, the “noise” measured within each square, for example, can be interpreted as everything except signal, and includes harmonic distortions caused by nonlinearities in the imager and target. Distortion typically varies with the square or higher power of the signal magnitude, but noise is fixed, therefore to accurately sense noise, pastelization can be performed on the target. For this reason, dark gray and light gray are chosen as one embodiment for square coloration rather than black and white. To minimize distortion, in one embodiment, the target is configured to be printed with unity gamma, with much lower contrast than the 1.8 to 2.2 gamma of normal color management, and also to receive the image from the camera, or convert it to, unity gamma before the inverse transform.

In an imaging system including compression, such as JPEG, or in a quantized system, the compression artifacts, including both added speckles, image components not articulated, and image components altered in compression, all show up as “noise” in the geometric patterns, e.g., squares. Thus, any deviation from the signal, including additions, deletions, and alterations, that would interfere with visual interpretation of an image can be classified as noise.

For a geometrical pattern of alternating squares of different gray scale colors, the power in the darker squares represents the noise while the power in the lighter squares represents the ‘signal+noise’. Thus, the noise and the ‘signal+noise’ energy can be found on two mutually exclusive quincunx lattices. Interpolation therefore provides an estimate of the noise and signal+noise power in all the geometric shapes. Therefore, the ratio signal+noise to noise (SN:N) can be used to derive a signal-to-noise component of the image data.

The signal-to-noise ratio enables a determination of the fraction of located geometric shapes that contain more image information than noise. More particularly, according to an embodiment, each geometric shape can be counted to determine which shapes contain a SN:N that is greater than a fixed threshold. In one embodiment, the threshold is chosen to be 2, which corresponds to equal signal and noise power. If the geometric shapes are squares, the geometric shapes with SN:N between 2 and 2.25 can be counted only as half and the squares with SN:N greater than 2.25 can be counted as full squares.

Another use for the signal-to-noise measurement includes determining the average amount of useful information. The average can be determined by taking a log to the base 2 of SN:N for each geometric shape. The total amount of information in bits can then be obtained by a summation of the result from taking the log. The average amount of information is then the total information divided by the total number of pixels in the image.

The frequency at which the geometric shapes start to disappear in each direction provides an estimate of the resolution of the image data. The determined frequency of drop-off corresponds to the extinguishing frequency and defines the extent to which detail can be reproduced in that direction. Using the transformed image data, the drop-off frequency can be determined by visually locating the frequency, by applying a computer program to determine the drop-off frequency, or by calculating the drop-off frequency compared to a threshold of information.

In another embodiment, the image data can be used to measure sharpness and noise as a function of brightness. More particularly, according to the embodiment, several exposures at different ambient levels are captured by the image capture device. In another embodiment, different ambient levels are determined using a single exposure to a target image with added attenuated versions of the target to a step wedge or other target that varies in brightness as a function of position. The image data can be measured from different gray steps in the target image and used to track sharpness and noise as a function of gray scale in one target image.

In another embodiment, an image target can be measured along different positions of the lens axis to measure image capture device resolution, both sagittal and tangential. A single larger target image can be used to measure the resolution information with a single exposure across the field. The image target can be captured at different focus settings to measure the modulation transfer function response of a lens to misfocus; for example spherical aberration introduces a soft focus in one polarity and hard misfocus in the other. As will be appreciated by those of skill in the art, there are many other variables that can be expressed in a measurement system using this target to measure sharpness and noise as a function of that variable.

While the subject matter of the application has been shown and described with reference to particular embodiments thereof, it will be understood by those skilled in the art that the foregoing and other changes in form and detail may be made therein without departing from the spirit and scope of the subject matter of the application, including but not limited to additional, less or modified elements and/or additional, less or modified blocks performed in the same or a different order. Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.). Those skilled in the art will recognize that it is common within the art to implement devices and/or processes and/or systems in the fashion(s) set forth herein, and thereafter use engineering and/or business practices to integrate such implemented devices and/or processes and/or systems into more comprehensive devices and/or processes and/or systems. That is, at least a portion of the devices and/or processes and/or systems described herein can be integrated into comprehensive devices and/or processes and/or systems via a reasonable amount of experimentation.

We claim:

1. A method for creating an image target for diagnostic testing of an image capture device, the method comprising:
choosing a pattern appropriate for image testing;
embedding the pattern into a reversible domain;
adding a random phase component in the reversible domain; and
transforming the pattern from the reversible domain to an inverse of the reversible domain; and
producing an image target for testing the image capture device from the transformed pattern.

2. The method of claim 1 wherein the choosing a pattern appropriate for image testing includes:
choosing one or more geometric shapes to create the pattern, the geometric shapes including one or more of a triangle, a square, a hexagon, star and/or impulse.

3. The method of claim 2 wherein the choosing one or more geometric shapes to create the pattern, the geometric shapes including one or more of a triangle, a square, a hexagon, star and/or impulse includes:
choosing alternating light and dark triangles to form at least two triplets within each hexagon to enable frequency angle agnostic testing of the image capture device.

4. The method of claim 2 wherein the choosing one or more geometric shapes to create the pattern, the geometric shapes including one or more of a triangle, a square, a hexagon, star and/or impulse includes:
positioning at least two star shapes on a hexagonal grid to enable high frequency image device testing and noise measurement.

5. The method of claim 1 wherein the choosing a pattern appropriate for image testing includes:
creating a pattern incorporating a color model representative of all color hues visible to the human eye.

6. The method of claim 1 wherein the choosing a pattern appropriate for image testing includes:
creating a pattern incorporating a color model including shapes directed to luminosity (L*), green-magenta (a*), and blue-yellow (b*).

7. The method of claim 6 wherein the creating a pattern incorporating a color model including shapes directed to luminosity (L*), green-magenta (a*), and blue-yellow (b*) includes:
positioning the geometric shapes so that green-magenta and blue-yellow shapes with two or more angles and one or more sizes.

8. The method of claim 6 wherein the creating a pattern incorporating a color model including shapes directed to luminosity (L*), green-magenta (a*), and blue-yellow (b*) includes:
sizing the luminosity shapes larger with respect to the green-magenta and blue-yellow shapes.

9. The method of claim 6 wherein the creating a pattern incorporating a color model including shapes directed to luminosity (L*), green-magenta (a*), and blue-yellow (b*) includes:
sizing the luminosity shapes larger with respect to the green-magenta and blue-yellow shapes to separate testing of luminance resolution and luminance noise of the image capture device.

10. The method of claim 6 wherein the creating a pattern incorporating a color model including shapes directed to luminosity (L*), green-magenta (a*), and blue-yellow (b*) includes:
applying a 30 degree angle to differentiate one or more shapes in the pattern, the one or more shapes colored according to the color model.

11. The method of claim 1 wherein the choosing a pattern appropriate for image testing includes:
creating a pattern incorporating a color model including shapes directed to luminosity (L*) and at least one color axis.

12. The method of claim 11 wherein the creating a pattern incorporating a color model including shapes directed to luminosity (L*) and at least one color axis includes:
positioning the geometric shapes so that green-magenta and blue-yellow shapes with two or more angles and one or more sizes.

13. The method of claim 1 1 wherein the creating a pattern incorporating a color model including shapes directed to luminosity (L*) and at least one color axis includes:
sizing the luminosity shapes larger with respect to the green-magenta and blue-yellow shapes.

14. The method of claim 11 wherein the creating a pattern incorporating a color model including shapes directed to luminosity (L*) and at least one color axis includes:
sizing the luminosity shapes larger with respect to the green-magenta and blue-yellow shapes to separate testing of luminance resolution and luminance noise of the image capture device.

15. The method of claim 11 wherein the creating a pattern incorporating a color model including shapes directed to luminosity (L*) and at least one color axis includes:
applying a 30 degree angle to differentiate one or more shapes in the pattern, the one or more shapes colored according to the color model.

16. The method of claim 1 wherein the choosing a pattern appropriate for image testing includes:
creating a pattern incorporating a color model including shapes directed to luminosity (L*) and exactly two color axis.

17. The method of claim 16 wherein the creating a pattern incorporating a color model including shapes directed to luminosity (L*) and exactly two color axis includes:
using green-magenta (a*) and blue-yellow(b*) for the exactly two color axis.

18. The method of claim 1 wherein the embedding the pattern into a reversible domain includes:
embedding one or more geometric patterns into a frequency domain to enable an inverse Fourier transform to produce a target image for testing the image capture device.

19. The method of claim 18 wherein the embedding one or more geometric patterns into a frequency domain to enable an inverse Fourier transform to produce a target image for testing the image capture device includes:
positioning the pattern in a left quadrant in of a two dimensional frequency domain.

20. The method of claim 1 wherein the embedding the pattern into a reversible domain includes:
inserting the pattern into a frequency domain.

21. The method of claim 1 wherein the embedding the pattern into a reversible domain includes:
inserting the pattern into a domain appropriate for one or more of a Fourier transform, reversible discrete cosine transform, and/or a reversible sine transform.

22. The method of claim 1 wherein the adding a random phase component in the reversible domain includes:
identifying a phase component for each unique coefficient in the reversible domain; and
randomizing each phase component over a phase circle associated with the reversible domain to uniformly distribute each randomized phase component.

23. The method of claim 22 wherein the randomizing each phase component over a phase circle associated with the reversible domain to uniformly distribute each randomized phase component includes:
randomizing using one of a symmetric random, anti-symmetric random or a pure random phase component.

24. The method of claim 22 wherein the randomizing each phase component over a phase circle associated with the reversible domain to uniformly distribute each randomized phase component includes:
uniformly distributing energy represented in the target image across the target image to generate a real-valued target image.

25. The method of claim 22 wherein the identifying a phase component for each unique coefficient in the reversible domain includes:
separating each frequency domain coefficient into a phase component and a magnitude component.

26. A method for testing an image capture device comprising:
receiving image data representative of a photographic image of a target image captured by the image capture device;
transforming the image data into a reversible domain to detect one or more patterns embedded in the reversible domain of the target image; and
comparing the reversible domain image data with the one or more geometric patterns embedded in the reversible domain.

27. The method of claim 26 wherein the receiving image data representative of a photographic image of a target image captured by the image capture device includes:
receiving the image data wherein the target image includes an embedded pattern visible upon transform to a reversible domain, the target image including a random phase component.

28. The method of claim 26 wherein the receiving image data representative of a photographic image of a target image captured by the image capture device includes:
receiving the image data via a network connection, a digital scan of the photographic image, and/or a computer input from an image data source.

29. The method of claim 26 wherein the transforming the image data into a reversible domain to detect one or more patterns embedded in the reversible domain of the target image includes:
performing a Fourier transform on at least a portion of the image data.

30. The method of claim 26 wherein the comparing the reversible domain image data with the one or more geometric patterns embedded in the reversible domain includes:
interpreting the image data by measuring a contrast between the geometric patterns.

31. The method of claim 26 wherein the comparing the reversible domain image data with the one or more geometric patterns embedded in the reversible domain includes:
determining a resolution of the image data by determining a drop-off frequency at which one or more shapes in the geometric patterns begin to disappear.

32. The method of claim 26 wherein the comparing the reversible domain image data with the one or more geometric patterns embedded in the reversible domain includes:
performing a two dimensional signal-to-noise analysis.

33. The method of claim 32 wherein the performing a two dimensional signal-to-noise analysis includes:
determining one or more values associated with one or more geometrical shapes of a first color attributable with noise power and one or more geometrical shapes of a second color attributable to signal with noise power added; and
interpolating the one or more values to estimate the noise and signal plus noise power in the geometric shapes of the first color and the geometric shapes of the second color.

34. The method of claim 32 wherein the performing a two dimensional signal-to-noise analysis includes:
determining a ratio of signal plus noise to noise for the image data; and
comparing a threshold to the ratio for each geometric shape represented in the image data to enable a signal to noise measure.

35. The method of claim 32 wherein the performing a two dimensional signal-to-noise analysis includes:
determining a ratio of signal plus noise to noise for the image data;
using the ratio to determine an average amount of information present in the image data.

36. A computer program product comprising:
a signal bearing medium bearing at least one of:
one or more instructions for choosing a pattern appropriate for image testing;
one or more instructions for embedding the pattern into a reversible domain; and
one or more instructions for producing an image target for testing the image capture device from the transformed pattern;
one or more instructions receiving image data representative of a photograph taken of the image target by the image capture device; and
one or more instructions for transforming the image data into a reversible domain to detect one or more patterns embedded in the reversible domain of the target image.

37. The computer program product of claim 36 wherein the signal bearing medium comprises:
a recordable medium.

38. The computer program product of claim 36 wherein the signal bearing medium comprises:
a transmission medium.
